(19) United States
(12) Patent Application Publication
(10) Pub. No.: US 2024/0326720 A1
(43) Pub. Date: Oct. 3, 2024

(54) GARNISH ASSEMBLY AND METHOD

(71) Applicant: Honda Motor Co., Ltd., Tokyo (JP)

(72) Inventors: Christopher Wayne EMERSON, Dublin, OH (US); David J. ROSE, West Mansfield, OH (US); Jesse W. SCHLABACH, Marysville, OH (US); Hirofumi TAKEMOTO, Dublin, OH (US); Jason S. BORLAND, Raymond, OH (US); Timothy J. RUPP, Dublin, OH (US)

(21) Appl. No.: 18/192,996

(22) Filed: Mar. 30, 2023

(51) Int. Cl. B60R 13/04

(52) U.S. Cl. CPC B60R 13/04

(57) ABSTRACT

A garnish assembly and method for a vehicle includes a garnish housing having a show surface delineated by an end edge surface for mounting on the vehicle. The garnish assembly further includes a seal extending along an entirety of the end edge surface and a doghouse structure adapted to mount the garnish housing and the seal to the vehicle. The seal is secured along the end edge surface wherein the end-to-end length of the seal matches an end-to-end length of the end edge surface. The doghouse structure is secured to the garnish housing so that attachment to the doghouse structure to the vehicle mounts the seal and the garnish housing to the vehicle.

### BACKGROUND

Garnishes are often used in vehicle assembly to provide a more pleasing aesthetic look, to prevent water intrusion, cover connection points on the vehicle, etc. One such use of a garnish is to house or overlap various connections provided or exposed on the exterior of the vehicle. One example of such a garnish is to cover the connection location at which a side view mirror on a vehicle is secured to the vehicle's frame or body. One means for connecting a garnish to a vehicle includes the use of a doghouse structure. By way of example, a doghouse structure can be used with an associated clip to secure to the vehicle's body and the garnish can then be connected to the doghouse structure. An example connection between a garnish and a doghouse structure is by heat staking. Sometimes a seal can be provided in association with the garnish for sealing against the elements and/or further improving vehicle aesthetics.

### BRIEF DESCRIPTION

According to one aspect, a garnish assembly for a vehicle includes a garnish housing having a show surface delineated by an end edge surface for mounting on the vehicle. The garnish assembly further includes a seal extending along an entirety of the end edge surface and a doghouse structure adapted to mount the garnish housing and the seal to the vehicle.

According to another aspect, a garnish assembly for covering a mirror attachment area on a vehicle includes a garnish housing having an end edge surface mounted in abutment with a fender of the vehicle. The garnish assembly further includes a seal extending along the end edge surface and a doghouse structure mounted to the fender. The doghouse structure is secured directly to the seal and the garnish housing to thereby mount the garnish housing to the vehicle.

According to a further aspect, a garnish assembly method for a vehicle includes providing a garnish housing having a show surface delineated by an end edge surface for mounting on the vehicle, providing a seal having an end-to-end length and providing a doghouse structure. The method further includes securing the seal along the end edge surface wherein the end-to-end length of the seal matches an end-to-end length of the end edge surface. The method also includes securing the doghouse structure to the garnish housing so that attachment to the doghouse structure to the vehicle mounts the seal and the garnish housing to the vehicle.

### BRIEF DESCRIPTION OF THE DRAWINGS

FIG. 1 is a schematic view of a known garnish assembly for a vehicle having a garnish housing, a seal, doghouse structures, and a secondary garnish housing.

FIG. 2 is a schematic cross-section view of the garnish assembly of FIG. 1 showing the secondary garnish housing securing the seal to the vehicle and covering upper ones of the doghouse structure, and showing the lack of any seal at an underside location at which a lower one of the doghouse structures secures the garnish housing to the vehicle.

FIG. 3 is a schematic view of a vehicle having a side view mirror attached to the vehicle at a mirror attachment location.

FIG. 4 is a partial enlarged view taken at location A of FIG. 3 showing a garnish assembly having a garnish housing, a seal and doghouse clip structures (shown in hidden lines) according to an exemplary embodiment.

FIGS. 5A, 5B, and 5C are schematic cross-section views taken, respectively, at the lines 5A-5A, 5B-5B, and 5C-5C of FIG. 4.

FIG. 6 is a schematic view of the garnish assembly of FIG. 4 shown with doghouse structures securing the garnish housing to the vehicle.

FIG. 7 is a schematic cross-section view taken at the line 7-7 of FIG. 6.

FIG. 8 is a schematic perspective view of a lower doghouse structure of the garnish assembly of FIG. 6.

FIG. 9 is a schematic cross-section view taken at the line 9-9 of FIG. 6.

FIG. 10 is a schematic plan view showing a profile of the garnish housing of FIG. 6.

FIG. 11 is a process flow diagram of a garnish assembly method for a vehicle according to an exemplary embodiment of the present disclosure.

### DETAILED DESCRIPTION

It should, of course, be understood that the description and drawings herein are merely illustrative and that various modifications and changes can be made in the structures disclosed without departing from the present disclosure. Spatially relative terms may be used to describe an element and/or features relationship to another element(s) and/or feature(s) as, for example, illustrated in the figures. Moreover, any term of degree used herein, such as “substantially” and “approximately,” means a reasonable amount of deviation of the modified word is contemplated such that the end result is not significantly changed.

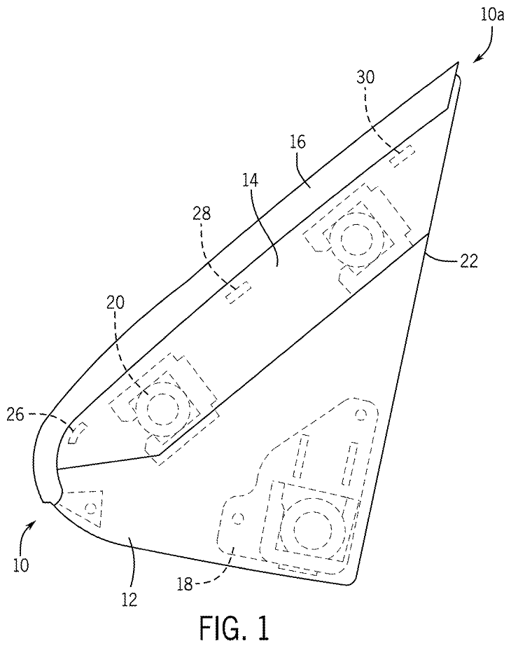

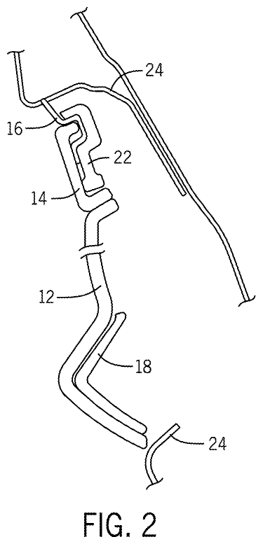

With reference now to the drawings, wherein like numerals refer to like parts throughout the several views, FIG. 1 schematically illustrates a known garnish assembly 10 for a vehicle. The known garnish assembly 10 includes a primary garnish housing 12 and a secondary garnish housing 14 secured to the primary garnish housing 12. Additionally, the garnish assembly 10 includes a seal 16 disposed along an upper area 10a of the garnish assembly 10 that is held in position by the secondary garnish housing 14. Also, the garnish assembly 10 includes a lower doghouse structure 18 and upper doghouse structures 20, 22 with all doghouse structures 18, 20, 22 independently provided relative to one another. The doghouse structures 18, 20, 22 are secured to a fender 24 (FIG. 2) of the vehicle on which the garnish assembly 10 is disposed and the garnish housing 12 is secured to the doghouse structures 18, 20, 22.

The secondary garnish housing 14 is specifically provided to overlay and hide the upper doghouse structures 20, 22. Additionally, the secondary garnish housing 14 can clinch the seal 16 as best shown in FIG. 2. In particular, the secondary garnish housing 14 can be heat staked to the primary garnish housing 12 at heat stake locations 26, 28, 30. Also, though not shown, the primary garnish housing 12 can be heat staked to the lower doghouse structure 18. A limitation of the known garnish assembly 10 is that the seal 16 is only provided along the upper area 10a and optionally heat staked to the secondary garnish housing 14 and/or the primary garnish housing 12 at the heat stake locations 26, 28, 30. In particular, as best shown in FIG. 2, the seal 16 is only present at the upper area 10a and no seal is disposed at the location where the primary garnish housing 12 meets the fender 24 adjacent the lower doghouse structure 18, i.e., along the lower edge or portion of the garnish assembly 10. Another limitation of the known garnish assembly 10 is that its surface geometry is required to be simplified to achieve the desired fit and finish on the vehicle. As such, the overall size of the known garnish assembly 10 is larger and/or more complex.

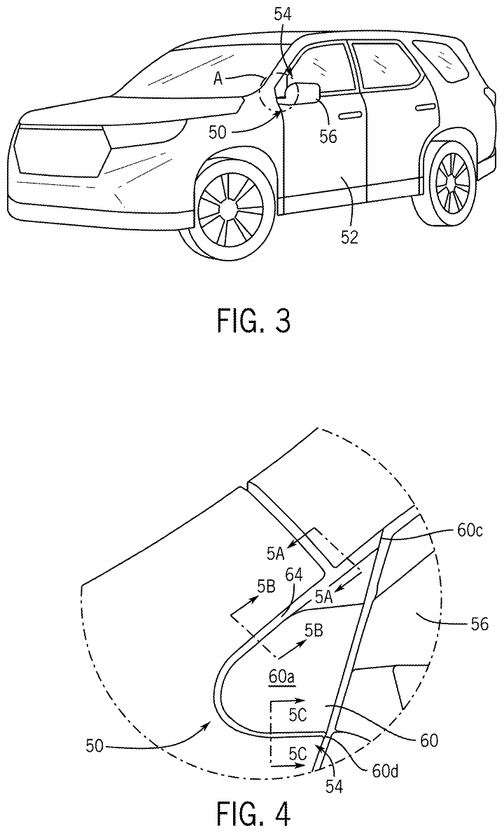

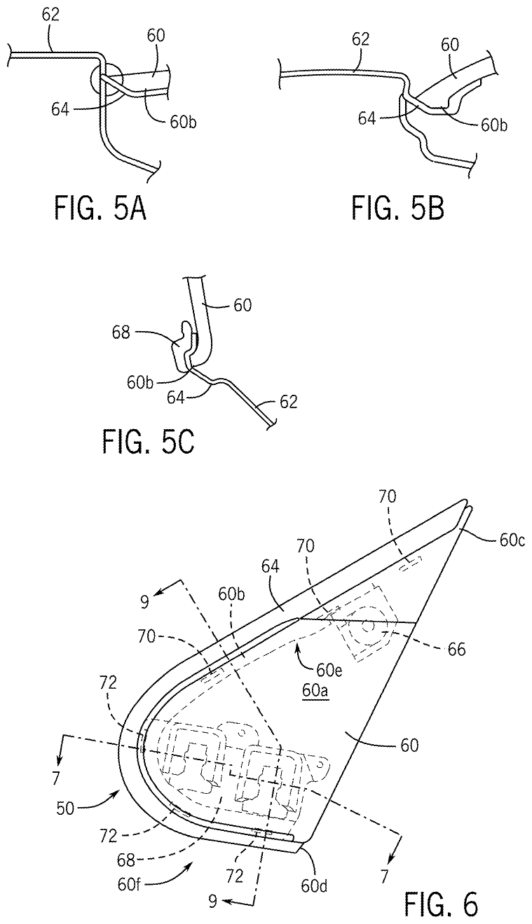

With reference now to FIGS. 3, 4, 5A-5C and 6, a garnish assembly 50 is shown for a vehicle 52 according to one exemplary embodiment of the present disclosure. In particular, the garnish assembly 50 is provided for covering a mirror attachment location or area 54 on the vehicle 52 at which a side view mirror 56 is mounted on the vehicle 52. The garnish assembly 50 includes a garnish housing 60 having a show surface 60a delineated by an end edge surface 60b (see FIGS. 5A-5C and 6) for mounting on the vehicle 52. The end edge surface 60b is mounted in abutment with a fender 62 of the vehicle 52. The end edge surface 60b can extend from an upper terminal end 60c to a lower terminal end 60d.

The garnish assembly 50 can further include a seal 64 extending along an entirety of the end edge surface 60b. More particularly, the seal 64 can extend along the end edge surface 60b from the upper terminal end 60c to the lower terminal end 60d (i.e., along an entirety of the end edge surface 60b). The seal 64 can be retained by the end edge surface 60b. More particularly, the end edge surface 60b of the garnish housing 60 can clinch or capture the seal 64 against the fender 62 of the vehicle 52.

The garnish assembly 50 can additionally include one or more doghouse structures, such as upper doghouse structure 66 and lower doghouse structure 68, adapted to mount the garnish housing 60 and the seal 64 to the vehicle 52, particularly to the fender 62 of the vehicle 52, at the mirror attachment location or area 54. More particularly, each of the doghouse structure 66, 68 can be mounted to the fender 62. Also, the doghouse structures 66, 68 can be secured directly to the seal 64 and the garnish housing 60 to thereby mount the seal 64 and the garnish housing 60 to the vehicle 52. Thus, the seal 64 can be sandwiched between the end edge surface 60b of the garnish housing 60 and the lower doghouse structure 68. In the illustrated embodiment, the garnish housing 60 fully encapsulates or covers both the lower doghouse structure 68 and the upper doghouse structure 66.

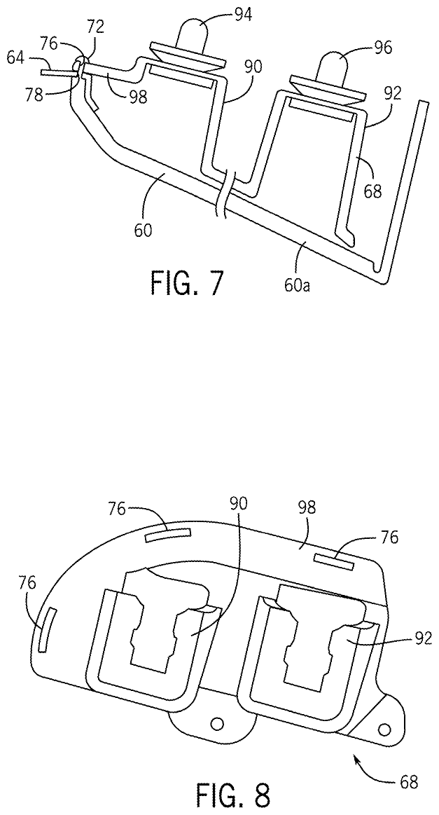

In one embodiment, one of the garnish housing 60 and the doghouse structure (e.g., doghouse structures 66 and/or 68) includes at least one heat stake (e.g., heat stakes 70, 72) and the other of the garnish housing 60 and the doghouse structure (doghouse structures 66 and/or 68) includes at least one heat stake aperture (e.g., heat stake apertures 76). More particularly, in the illustrated embodiment, the garnish housing 60 includes a plurality of heat stakes 70, 72, including upper heat stakes 70 disposed adjacent the upper portion 60e and lower heat stakes 72 disposed adjacent the lower portion 60f. The lower heat stakes 72 are received through heat stack apertures 76 defined in the lower doghouse structure 68 (see FIG. 8). Optionally, though not shown in the illustrated embodiment, one of the heat stakes 70 could be received through a heat stake aperture defined in the upper doghouse structure 66. After receipt through heat stake apertures (e.g., heat stake apertures 76), the application of heat is applied to the heat stakes 70, 72 to form a permanent connection as is known and understood by those skilled in the art.

In addition, the seal 64 can include at least one seal heat stake aperture (e.g., seal heat stake apertures 78) that receives the at least one heat stake (e.g., heat stakes 70, 72) of the garnish housing 60. More particularly, in the illustrated embodiment, the seal 64 includes a plurality of seal heat stake apertures 78 disposed along a length (also referred to herein as an end-to-end dimension) of the seal 64. The heat stakes 70 disposed along the upper portion 60e and the heat stakes 72 disposed along the lower portion 60f are received through seal heat stake apertures 78, so that the seal 64 is heat staked along its entire length to the garnish housing 60. More particularly, the heat stakes 72 are received through both the heat stake apertures 76 of the lower doghouse structure 68 and through adjacent ones of the seal heat stake apertures 78.

More particularly, in the illustrated embodiment, the at least one heat stake can be a plurality of heat stakes 72, 74 disposed along the end-to-end dimension of the end edge surface 60b of the garnish housing 60. As used herein, the end-to-end dimension of the end edge surface 60b can be a dimension that extends along a length of the end edge surface 60b from the upper terminal end 60c to the lower terminal end 60d. By this arrangement, the garnish housing 60 includes the plurality of heat stakes 70, 72 disposed along the end-to-end dimension of the end edge surface 60b and these heat stakes 70, 72 are received within the seal heat stake apertures 78 provisioned along an entirety of the seal 64.

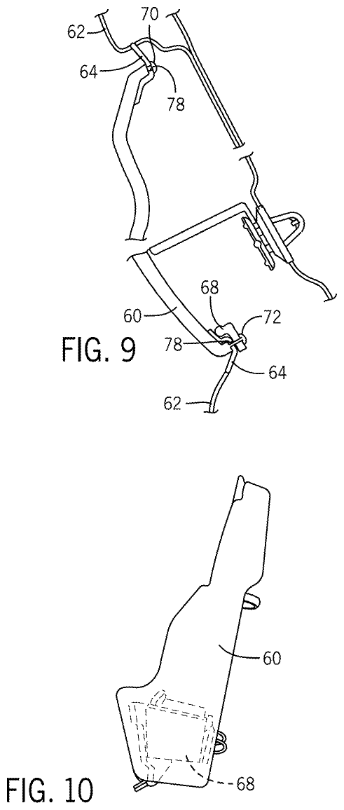

With particular reference to FIG. 7, one of the heat stakes 72 is illustrated passing through one of the seal heat stake apertures 78 and through one of the heat stake apertures 76 defined in the lower doghouse structure 68. With specific reference to FIG. 9, another of the heat stakes 72 is illustrated passing through one of the seal heat stake apertures 78 and through one of the heat stake apertures 76 defined in the lower doghouse structure 68. Also shown in FIG. 9 is one of the heat stakes 70 passing through one of the seal heat stake apertures 78 defined in the seal 64 (and not passing through any aperture in any doghouse structure).

With reference to FIGS. 7 and 8, the lower doghouse structure 68 is shown in more detail. In particular, the lower doghouse structure 68 of the illustrated embodiment includes a pair of spaced apart doghouse clip structures or structure portions 90, 92 with doghouse clips 94, 96 respectively received therein for securing the doghouse structure 68 to the vehicle 52. In particular, the clip structures 90, 92 can be a pair of integrally formed and spaced apart clip structures for slidably receiving the associated clips 94, 96 therein, with the associated clips 94, 96 connecting to the fender 62 of the vehicle 52. As shown, the doghouse structure 68 includes an apron portion 98 along which the heat stake apertures 76 are disposed.

Advantageously, the seal 64 is fully secured to the garnish housing 60 via the heat stakes 70, 72 and the lower doghouse structure 68 ensures consistent fit and finish of the garnish housing 60 to the vehicle 52. Also advantageously, the overall size of the garnish assembly 50 can be small as all attachment points (i.e., heat stakes 70, 72) are included within the garnish housing 60 so that no secondary garnish housing (e.g., secondary garnish housing 14 of known garnish assembly 10 of FIGS. 1 and 2) is needed. Since the lower doghouse structure 68 is heat staked to the garnish housing 60, the seal 64 is secured around an entirety of the garnish housing 60 (i.e., the seal 64 is secured along its entire length to the end edge surface 60b along an end-to-end dimension of the end edge surface 60b), which also ensures consistent fit and finish as well as satisfactory retention. The lower doghouse structure 68 also ensures that the seal 64 remains clinched between and retained in its proper position.

With additional reference to FIG. 10, retention of the garnish housing 60 to the vehicle 52 is also improved as the doghouse clip structures 90, 92 are not able to move relative to one another. Advantageously, as illustrated, the outer geometry of the garnish housing 60 is able to follow more desired styling because the lower doghouse structure 68 allows for more complex molds as, unlike the known garnish assembly 10, there is no need to include slides or lifters for the doghouses.

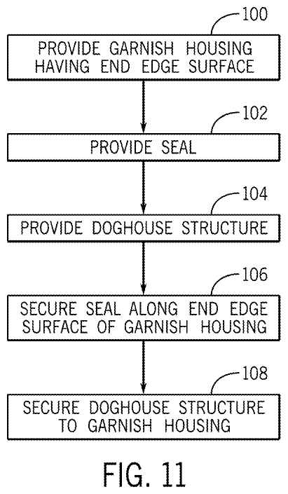

With reference now to FIG. 11, a garnish assembly method for a vehicle will now be described. In particular, the garnish assembly method will be described in association with the garnish assembly 50 and vehicle 52 described hereinabove, though this is not required and the garnish assembly method could be used with other garnish assemblies 50. In the method, at 100, the garnish housing 60 having the show surface 60a delineated by the end edge surface 60b for mounting to the vehicle 52 is provided. At 102, the seal 64 having its end-to-end length is provided. At 104, the doghouse structure 68 is provided. Additionally, at 104, the upper doghouse structure 66 could also be provided.

At 106, the seal 64 is secured along the end edge surface 60b of the garnish housing 60 wherein the end-to-end length of the seal 64 matched the end-to-end length of the end edge surface 60b. At 108, the doghouse structure 68 is secured to the garnish housing 60, such as via the heat stakes 72 being received in the heat stake apertures 76, so that attachment of the doghouse structure 68 to the vehicle 52 mounts the seal 64 and the garnish housing 60 to the vehicle 52.

It will be appreciated that various of the above-disclosed and other features and functions, or alternatives or varieties thereof, may be desirably combined into many other different systems or applications. Also that various presently unforeseen or unanticipated alternatives, modifications, variations or improvements therein may be subsequently made by those skilled in the art which are also intended to be encompassed by the following claims.

1. A clamp for measuring a tension of a conveyor belt, the clamp including a clamping portion arranged to engage with opposing faces of the conveyor belt in a clamped condition to hold the conveyor belt relative to an anchor, and a load sensing arrangement including at least one sensor between the clamping portion and the anchor, the load sensing arrangement configured to provide a signal indicative of the tension in the conveyor belt in the clamped condition, wherein the clamping portion includes a first clamping section, a second clamping section and a pivotal coupling arranged such that the first clamping section is pivotally moveable relative to the second clamping section to engage with the conveyor belt in the clamped condition.

2. The clamp according to claim 1, wherein the at least one load sensor is arranged to measure at least a load applied in a direction inline with the belt.

3. (canceled)

4. (canceled)

5. The clamp according to claim 1, wherein the load sensing arrangement is connected to the first clamping section so as to be moveable therewith.

6. The clamp according to claim 5, wherein the load sensing arrangement includes a load sensing section between the first clamping section and the anchor, and wherein the load sensing section carries the at least one load sensor.

7. The clamp according to claim 6, wherein the load sensing section has a substantially dog-bone shape.

8. The clamp according to claim 6, wherein the at least one load sensor is provided in the form of two strain gauges each located proximate respective opposing upper and lower surfaces of the load sensing section.

9. The clamp according to claim 6, wherein a free end of the load sensing section is coupled with an anchor point that is in turn coupled with the anchor in the clamped condition.

10. The clamp according to claim 1, wherein the second clamping section is substantially fixed.

11. The clamp according to claim 1, wherein the clamp includes a main body with a top and a bottom, the second clamping section being provided toward the top and the first clamping section being pivotally supported by the pivotal coupling arranged between the bottom and the first clamping section.

12. The clamp according to claim 1, wherein the pivotal coupling is arranged to maintain a first clamping surface of the first clamping section substantially parallel to the conveyor belt.

13. The clamp according to claim 1, wherein the pivotal coupling is arranged to allow the first clamping section to increase a clamping force on the belt in response to an increase in tension in the conveyor belt.

14. The clamp according to claim 1, wherein the pivotal coupling includes two parallel members pivotally coupled at spaced apart locations between the bottom and the first clamping section.

15. The clamp according to claim 1, wherein the main body includes opposing sides between the top and the bottom, one of the opposing sides having a slot in which an edge of the conveyor belt is receivable.

16. The clamp according to claim 1, wherein the clamp includes a retainer arranged to maintain the clamp in the clamped condition.

17. The clamp according to claim 1, wherein the load sensing arrangement includes a communication device arranged to communicate a signal indicative of the tension to an external device.

18. The clamp according to claim 1, wherein the clamp is one-of a pair of clamps provided to couple with opposing side edges of a conveyor belt.

19. A system for detecting load in a conveyor belt, the system including:
a. A pair of edge clamps each having respective clamping portions adapted to clampingly engage with opposing side edges of the conveyor belt in a clamped condition, the respective clamping portions each having a first clamping section, a second clamping section and a pivotal coupling arranged such that the first clamping section is pivotally moveable relative to the second clamping section to engage with the conveyor belt in the clamped condition;
b. An anchoring arrangement arranged to couple with an anchor point of the pair of edge clamps to anchor the pair of edge clamps to a fixed structure;
c. A load sensing arrangement including a load sensing section located between at least one of the respective clamping portions of the pair of edge clamps and the anchoring arrangement, each load sensing section including a load sensor and a communication device arranged to communicate a load signal; and
d. A receiving device configured to receive the load signal so as to provide an indication of a tension in the conveyor belt in the clamped condition.

20. A method for detecting load in a conveyor belt, the method including the steps of:
a. Fitting a pair of edge clamps to opposing edges of the conveyor belt and pivotally moving at least one of the respective clamping portions of the pair of edge clamps to engage with opposing side edges of the conveyor belt in a clamped condition;
b. Coupling an anchoring arrangement to a load sensing section associated with one or both of the clamping portions of each pair of edge clamps;
c. Transmitting, via a communication device associated with load sensors fitted to each load sensing section, a load signal; and
d. Receiving, at a receiving device, the load signal so as to provide an indication of a tension in the conveyor belt in the clamped condition.

21. (canceled)

22. (canceled)

23. (canceled)

24. (canceled)

25. A clamp for measuring a tension of a conveyor belt, the clamp including a main body and a clamping portion arranged to engage with opposing faces of the conveyor belt in a clamped condition to hold the conveyor belt relative to an anchor, and a load sensing arrangement between the clamping portion and the anchor, the load sensing arrangement configured to provide a signal indicative of the tension in the conveyor belt in the clamped condition, wherein the clamping portion includes a first clamping section and a second clamping section, the first clamping section being pivotally supported by a pivotal coupling between the first clamping member and the main body.

26. A clamp for measuring a tension of a conveyor belt, the clamp including a clamping portion arranged to engage with opposing faces of the conveyor belt in a clamped condition to hold the conveyor belt relative to an anchor, and a load sensing arrangement between the clamping portion and the anchor, the load sensing arrangement configured to provide a signal indicative of the tension in the conveyor belt in the clamped condition, wherein the clamp includes a retainer arranged to maintain the clamp in the clamped condition.

27. A system for detecting load in a conveyor belt, the system including:
a. A pair of edge clamps each having respective clamping portions adapted to clampingly engage with opposing side edges of the conveyor belt in a clamped condition, wherein each of the pair of edge clamps include a retainer to maintain each of the pair of edge clamps in the clamped condition;
b. An anchoring arrangement arranged to couple with an anchor point of the pair of edge clamps to anchor the pair of edge clamps to a fixed structure;
c. A load sensing arrangement including a load sensing section located between at least one of the respective clamping portions of the pair of edge clamps and the anchoring arrangement, each load sensing section including a load sensor and a communication device arranged to communicate a load signal; and
d. A receiving device configured to receive the load signal so as to provide an indication of a tension in the conveyor belt in the clamped condition.

28. A method for detecting load in a conveyor belt, the method including the steps of:
a. Fitting a pair of edge clamps to opposing edges of the conveyor belt and moving at least one of the respective clamping portions of the pair of edge clamps to engage with opposing side edges of the conveyor belt in a clamped condition, and actuating a retainer associated with each of the pair of edge clamps to maintain each of the pair of edge clamps in the clamped condition;
b. Coupling an anchoring arrangement to a load sensing section associated with one or both of the clamping portions of each pair of edge clamps;
c. Transmitting, via a communication device associated with load sensors fitted to each load sensing section, a load signal; and
d. Receiving, at a receiving device, the load signal so as to provide an indication of a tension in the conveyor belt in the clamped condition.
